(19) United States
(12) Patent Application Publication
(10) Pub. No.: US 2021/0390134 A1
(43) Pub. Date: Dec. 16, 2021

(54) Presentation file generation

(71) Applicant: Photo Butler Inc., Easton, MA (US)

(72) Inventors: Craig Carlson, Wakefield, MA (US); Zhikang Ding, Malden, MA (US); Joseph C. Cuccinelli, Jr., Needham, MA (US); David Benaim, Newton Centre, MA (US); Joe Regan, Boston, MA (US); Tricia Chang, Somerville, MA (US); Andrew P. Goldfarb, Brookline, MA (US)

(21) Appl. No.: 17/294,988

(22) PCT Filed: Nov. 26, 2019
(86) PCT No.: PCT/US2019/063202

§ 371 Date: Jun. 30, 2021

Related U.S. Application Data
(60) Provisional application No. 62/771,548, filed on Nov. 26, 2018.

(51) Int. Cl. G06F 16/583; G06F 16/55; G06F 16/538; G06F 16/535

(52) U.S. Cl. CPC G06F 16/583; G06F 16/535; G06F 16/538; G06F 16/55

(57) ABSTRACT

Methods and systems for generating a presentation file. The systems and methods described herein may analyze received imagery in accordance with one or more criterion, and then select at least a portion of the received imagery based on the portion satisfying the at least one criterion. The systems and methods may then generate a presentation file such as a video slideshow that includes the selected imagery portion(s).

### CROSS-REFERENCE TO RELATED APPLICATIONS

The present application claims the benefit of co-pending U.S. provisional application No. 62/771,548, filed on Nov. 26, 2018, the entire disclosure of which is incorporated by reference as if set forth in its entirety herein.

### TECHNICAL FIELD

The present application generally relates to systems and methods for generating a presentation file of imagery and, more particularly but not exclusively, to systems and methods for generating a presentation file of imagery based on the imagery satisfying one or more criteria.

### BACKGROUND

People experiencing events such as sporting competitions, vacations, festivals, or some other type of event occurring over a period of time may want to share their gathered imagery with others or otherwise want a way to view gathered imagery in an entertaining and easy manner. Existing techniques for selecting and presenting gathered imagery, however, do not provide many options with respect to how imagery is selected and presented. Additionally, these existing methods for selecting and presenting imagery involve manually selecting imagery, which is a time-intensive process.

A need exists, therefore, for systems and methods for generating a presentation of imagery that overcome the disadvantages of existing techniques.

### SUMMARY

This summary is provided to introduce a selection of concepts in a simplified form that are further described below in the Detailed Description section. This summary is not intended to identify or exclude key features or essential features of the claimed subject matter, nor is it intended to be used as an aid in determining the scope of the claimed subject matter.

In one aspect, embodiments relate to a method of generating a presentation file. The method includes receiving imagery at an interface, receiving at the interface at least one criterion for selecting imagery from the received imagery, analyzing the received imagery in accordance with the received at least one criterion, selecting at least a portion of the received imagery based on the portion satisfying the at least one criterion, and autonomously generating the presentation file that includes the selected portion of the received imagery.

In some embodiments, the method further includes assigning a score to the received imagery that represents whether the received imagery satisfies the received at least one criterion. In some embodiments, selecting at least a portion of the received imagery comprises selecting imagery with an assigned score above a threshold. In some embodiments, the score assigned to the received imagery is based on at least one item of interest in the received imagery, wherein the item of interest is selected from the group consisting of a person in the imagery, a location where the imagery was taken, a date the imagery was taken, a time the imagery was taken, a point of interest associated with the imagery, and object of interest in the imagery, and at least one imagery aesthetic. In some embodiments, a higher score is assigned to a first portion of imagery that includes more items of interest than a score assigned to a second portion of imagery with fewer items of interest.

In some embodiments, the method further includes generating at least one textual caption to accompany the selected portion of the received imagery in the generated presentation file. In some embodiments, the at least one textual caption describes at least one of a person in the selected portion of the received imagery, an activity occurring in the selected portion of the received imagery, a point of interest in the imagery, and an object of interest in the imagery.

In some embodiments, receiving the imagery at an interface includes receiving the imagery from a plurality of users.

In some embodiments, the method further includes executing a computer vision procedure to review the received imagery for duplicate imagery and preventing duplicate imagery from being included in the generated presentation file.

In some embodiments, analyzing the received imagery includes a computer vision procedure to review the imagery to detect similar imagery, wherein selecting at least a portion of the received imagery includes selecting imagery portions that are most dissimilar to ensure the generated file presentation includes diverse imagery.

In some embodiments, the method further includes, based on the analysis of the received imagery, recommending a template to be used to generate the presentation file.

In some embodiments, generating the presentation file includes selecting at least one filter to be used, and applying the at least one filter to at least a portion of the selected imagery.

In some embodiments, the method further includes sorting the imagery into a plurality of time segments based on when the imagery was taken, and wherein selecting at least a portion of the received imagery comprises selecting imagery from each of the plurality of time segments, with the amount of imagery selected from each of the plurality of time segments being proportional to the amount of imagery in each of the plurality of time segments.

In some embodiments, generating the presentation file that includes the selected portion of the received imagery includes applying at least one filter to the selected portion of the received imagery, wherein the applied filter is based on content of the received imagery.

In some embodiments, analyzing the received imagery includes executing a computer vision procedure, and the method further includes executing a cropping procedure to crop the portion of the selected imagery based on the execution of the computer vision procedure.

According to another aspect, embodiments relate to a system for generating a presentation file. The system includes an interface for receiving imagery and at least one criterion for selecting imagery from the received imagery, and a processor executing instructions stored on memory and configured to an analyze the received imagery in accordance with the received at least one criterion, select at least a portion of the received imagery based on the portion satisfying the at least one criterion, and autonomously generate the presentation file that includes the at least one selected portion of the received imagery.

In some embodiments, the processor is further configured to assign a score to the received imagery that represents whether the received imagery satisfies the at least one criterion. In some embodiments, the processor selects the at least a portion based on the portion having an assigned score above a threshold. In some embodiments, the score assigned to the received imagery is based on at least one item of interest in the received imagery, wherein the item of interest is selected from the group consisting of a person in the imagery, a location where the imagery was taken, a date the imagery was taken, a time the imagery was taken, a point of interest associated with the imagery, an object of interest in the imagery, and at least one imagery aesthetic. In some embodiments, a higher score is assigned to a first portion of imagery that includes more items of interest than a score assigned to a second portion of imagery with fewer items of interest.

In some embodiments, the processor is further configured to generate at least one textual caption to accompany the selected portion of the received imagery in the generated presentation file.

In some embodiments, the at least one textual caption describes at least one of a person in the selected portion of the received imagery, an activity occurring in the selected portion of the received imagery, a point of interest in the imagery, and an object of interest in the imagery.

In some embodiments, the imagery is received from a plurality of users.

In some embodiments, the processor is further configured to execute a computer vision procedure to review the received imagery for duplicate imagery and prevent duplicate imagery from being included in the generated presentation file.

In some embodiments, the processor is further configured to execute instructions stored in memory to autonomously analyze metadata associated with the received imagery and sort the selected imagery into a plurality of time segments based on when the imagery was taken, wherein the amount of imagery selected from each of the plurality of time segments is proportional to the amount of imagery in each of the plurality of time segments.

In some embodiments, the processor is further configured to assign a transition effect between presentation of at least two imagery portions of the generated presentation file

### BRIEF DESCRIPTION OF DRAWINGS

Non-limiting and non-exhaustive embodiments of this disclosure are described with reference to the following figures, wherein like reference numerals refer to like parts throughout the various views unless otherwise specified.

FIG. 1 illustrates a system for generating a presentation file in accordance with one embodiment;

FIG. 2 illustrates the imagery analysis module of FIG. 1 in accordance with one embodiment;

FIG. 3 depicts a flowchart of a method for generating a presentation file in accordance with one embodiment; and

FIG. 4 depicts a flowchart of a method for generating a presentation file in accordance with another embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment. The appearances of the phrase “in some embodiments” in various places in the specification are not necessarily all referring to the same embodiments.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

The embodiments described herein provide novel ways to analyze imagery to generate a presentation file of imagery such as a video slideshow. To determine which imagery is appropriate for use in a slideshow, the embodiments described herein may rely on any one or more of facial recognition, optical character recognition (OCR), landmark or object detection, time data, location data, season data, or the like to analyze received imagery. Each imagery portion may also include or otherwise be associated with a content tag describing the content of the gathered imagery.

OCR and other techniques may be used to identify text contained in a portion of imagery as well as imagery aesthetics. The systems and methods described herein can detect and recognize the content of signs, messages, players' jerseys, and other relevant text to learn about the imagery and to personalize a generated presentation file. Based on the analysis of the imagery, the systems and methods described herein may select templates for use in generating the presentation file, identify people of interest in the imagery, select filters for use in the generated presentation file, select transitions of different portions of the presentation file, or the like.

Embodiments described herein provide systems and methods to personalize and generate a presentation file based on one or more criterion such as, for example, who is featured in the gathered imagery, the time associated with the gathered imagery, the date associated with the gathered imagery, the location associated with the gathered imagery, points of interest (POI) associated with the gathered imagery, or the like.

The systems and methods described herein can dynamically personalize the generated presentation file by applying filters, captions, music, transitions, and effects that are relevant to the aforementioned identifiers or features. Accordingly, this enables the systems and methods described herein to deliver a more engaging presentation file. Although the present application largely discusses generating a presentation file such as a video slideshow, the systems and methods described herein may be used to create other types of files such as book layouts, calendars, albums, or the like.

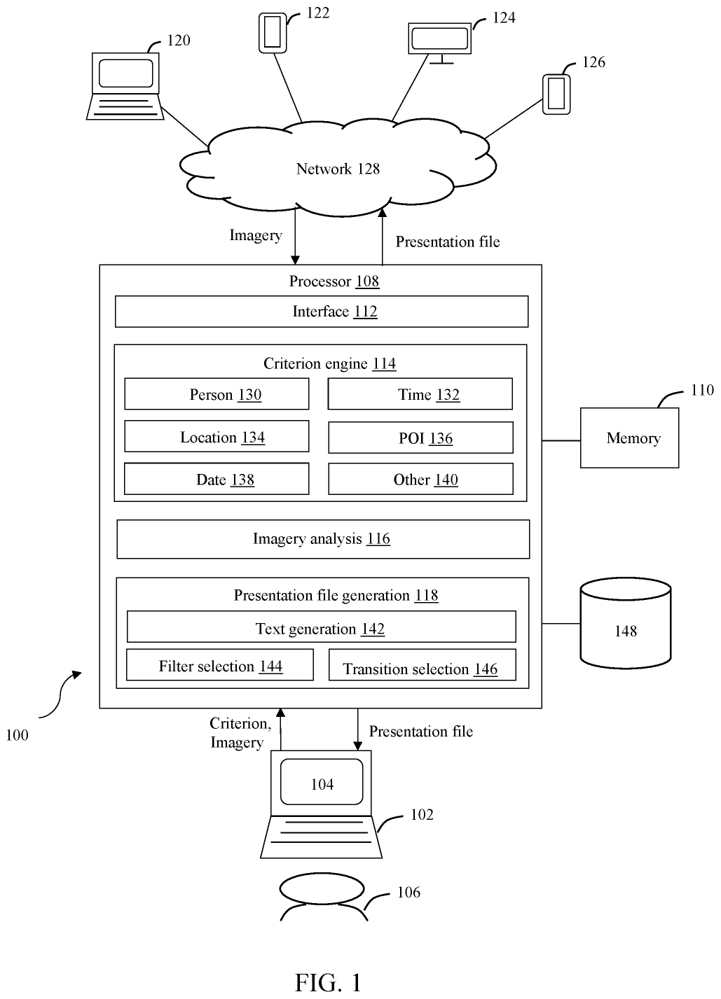

FIG. 1 illustrates a system 100 for generating a presentation file in accordance with one embodiment. The system 100 may include a user device 102 executing a user interface 104 for presentation to a user 106. The user 106 may be a person interested in uploading imagery and having provided imagery compiled into a presentation file such as a video slideshow.

The user device 102 may be any hardware device capable of executing the user interface 104. The user device 102 may be configured as a laptop, PC, tablet, mobile device, television, or the like. The exact configuration of the user device 102 may vary as long as it can execute and present the user interface 104 to the user 106. The user interface 104 may allow the user 106 to provide imagery and criterion for selecting imagery to be included in the generated presentation file, as well as to view the generated presentation file.

The user device 102 may be in operable communication with one or more processors 108. The processor(s) 108 may be any one or more of hardware devices capable of executing instructions stored on memory 110 to accomplish the objectives of the various embodiments described herein. The processor(s) 108 may be implemented as software executing on a microprocessor, a field programmable gate array (FPGA), an application-specific integrated circuit (ASIC), or another similar device whether available now or invented hereafter.

In some embodiments, such as those relying on one or more ASICs, the functionality described as being provided in part via software may instead be configured into the design of the ASICs and, as such, the associated software may be omitted. The processor(s) 108 may be configured as part of the user device 102 on which the user interface 104 executes, such as a laptop, or may be located on a different computing device, perhaps at some remote location or configured as a cloud-based solution.

The processor 108 may execute instructions stored on memory 110 to provide various modules to accomplish the objectives of the various embodiments described herein. Specifically, the processor 108 may execute or otherwise include an interface 112, a criterion engine 114, an imagery analysis module 116, and a presentation file generation module 118.

The memory 110 may be L1, L2, L3 cache or RAM memory configurations. The memory 110 may include non-volatile memory such as flash memory, EPROM, EEPROM, ROM, and PROM, or volatile memory such as static or dynamic RAM, as discussed above. The exact configuration/type of memory 110 may of course vary as long as instructions for generating a presentation file can be executed by the processor 108 to accomplish the features of various embodiments described herein.

The processor 108 may receive imagery from the user 106 as well as one or more members 120, 122, 124, and 126 over one or more networks 128. The members 120, 122, 124, and 126 are illustrated as devices such as laptops, smartphones, smartwatches and PCs, or any other type of device configured or otherwise in operable communication with an imagery gathering device (e.g., a camera) to gather imagery.

The present application largely describes embodiments in which the user 106 of user device 102 gathers and shares imagery and other members or users view the imagery and the generated presentation file. However, in some embodiments, the members 120, 122, 124, and 126 may contribute their own imagery for use in generating the presentation file.

In various embodiments the sharing of imagery can be bi-directional. That is, the members 120, 122, 124, and 126 can solely be viewers (and not contributing imagery), or contributors, in which case they contribute their imagery and may view other imagery included in the generated presentation file(s). As a contributor, a member may supply imagery that, if it satisfies specified criteria, may be included in the generated presentation file.

When a user 106 creates or shares a presentation file project, he or she can indicate if they want a certain member to be a contributor or a viewer. If a person is invited to be a project member, he or she can accept as a contributor or only as a viewer. At a later date, the invitee or the project creator may change their status.

The network(s) 128 may link the various assets and components with various types of network connections. The network(s) 128 may be comprised of, or may interface to, any one or more of the Internet, an intranet, a Personal Area Network (PAN), a Local Area Network (LAN), a Wide Area Network (WAN), a Metropolitan Area Network (MAN), a storage area network (SAN), a frame relay connection, an Advanced Intelligent Network (AIN) connection, a synchronous optical network (SONET) connection, a digital T1, T3, E1, or E3 line, a Digital Data Service (DDS) connection, a Digital Subscriber Line (DSL) connection, an Ethernet connection, an Integrated Services Digital Network (ISDN) line, a dial-up port such as a V.90, a V.34, or a V.34bis analog modem connection, a cable modem, an Asynchronous Transfer Mode (ATM) connection, a Fiber Distributed Data Interface (FDDI) connection, a Copper Distributed Data Interface (CDDI) connection, or an optical/DWDM network.

The network(s) 128 may also comprise, include, or interface to any one or more of a Wireless Application Protocol (WAP) link, a Wi-Fi link, a microwave link, a General Packet Radio Service (GPRS) link, a Global System for Mobile Communication G(SM) link, a Code Division Multiple Access (CDMA) link, or a Time Division Multiple access (TDMA) link such as a cellular phone channel, a Global Positioning System (GPS) link, a cellular digital packet data (CDPD) link, a Research in Motion, Limited (RIM) duplex paging type device, a Bluetooth radio link, or an IEEE 802.11-based link.

The database(s) 130 may store imagery and other data related to, for example, certain people (e.g., their facial features), places, calendar events (and items associated with calendar events), or the like. In other words, the database(s) 130 may store data regarding specific people or other entities such that the imagery analysis module 116 can recognize these people or entities in received imagery. The exact type of data stored in the database(s) 130 may vary as long as the features of various embodiments described herein may be accomplished.

The processor interface 112 may receive imagery from the user device 102 (e.g., a camera of the user device 102) in a variety of formats. The imagery may be sent via any suitable protocol or application such as, but not limited to, email, SMS text message, iMessage, Whatsapp, Facebook, Instagram, Snapchat, other social media platforms or messaging applications, etc. The interface 112 may then communicate the imagery to the imagery analysis module 116.

In the context of the present application, the term “imagery” may refer to photographs, videos (e.g., frames of which may be analyzed), mini clips, animated photographs, video clips, animated images, motion photos, or the like. The systems and methods may analyze the imagery received from the user 106, other members 120, 122, 124, and 126, one or more databases 130, or some combination thereof to select one or more imagery portions to be included in the generated presentation file. In the context of the present application, the term “imagery portion” or the like may refer to an individual imagery file, such as a single photograph or video. Accordingly, a generated presentation file may include several portions of imagery.

In operation, a user 106 may provide one or more criteria via the criterion engine 114. Specifically, the provided criterion may specify the content required to be in a portion of imagery in order for the portion of imagery to be included in a generated presentation file. For example, specified criteria may relate to any one or more of a person in the imagery, a location where the imagery was taken, a date the imagery was taken, a time the imagery was taken, a point of interest associated with the imagery, and an item of interest in the imagery.

The criterion engine 114 may execute various sub-modules to enable the user to define criteria for generating a presentation file. These may include a person sub-module 130 to specify one or more people to be in the imagery before imagery is selected, a time module 132 to specify time criteria to be satisfied before imagery is selected, a location sub-module 134 to specify a location to be satisfied before imagery is selected, a point-of-interest (POI) sub-module 136 to specify a POI to be present within imagery before imagery is selected, a date sub-module 138 to specify a date which imagery should match before inclusion in the presentation file, and a miscellaneous sub-module 140 to consider other features such as photoaesthetics (discussed below).

For example, a user 106 may want a presentation file to include photos and videos of their friends Lucy and Caroline on Nantucket during the previous (or upcoming) summer. Or, the user 106 may want a presentation file to only include photos and videos of Jack during all previous Christmas seasons and all future Christmas seasons. Accordingly, the person sub-module 130 may receive as input the names of people from the user interface 104 with associated imagery to be included in the generated presentation file, and the time sub-module 132 or date sub-module 138 may receive dates or times of imagery to be included in the generated presentation file.

Additionally, the criterion engine 114 may load templates stored in the database 148 that provide proprietary filters to help users define criteria for imagery. For example, the database 148 may include a “Graduation” rules-based album template. If this template is selected, pre-defined criterion may be that imagery portions include objects such as a mortar board, a podium, a diploma, and other relevant graduation-related objects.

As another example, the database 148 may include a “Sports” rules-based album template. If this template is selected, pre-defined criteria may be that imagery portions include soccer balls, baseballs, bats, lacrosse sticks, hockey sticks, basketball hoops, referees (e.g., a person wearing black and white stripes), fields, courts, hockey rinks, gymnasiums, golf courses, or the like.

As another example, the database 148 may include a “Concert” rules-based template. If this template is selected, pre-defined criteria may be that imagery portions include objects such as, but not limited to, a concert stage, musical instruments, light shows, and dark, crowded scenes.

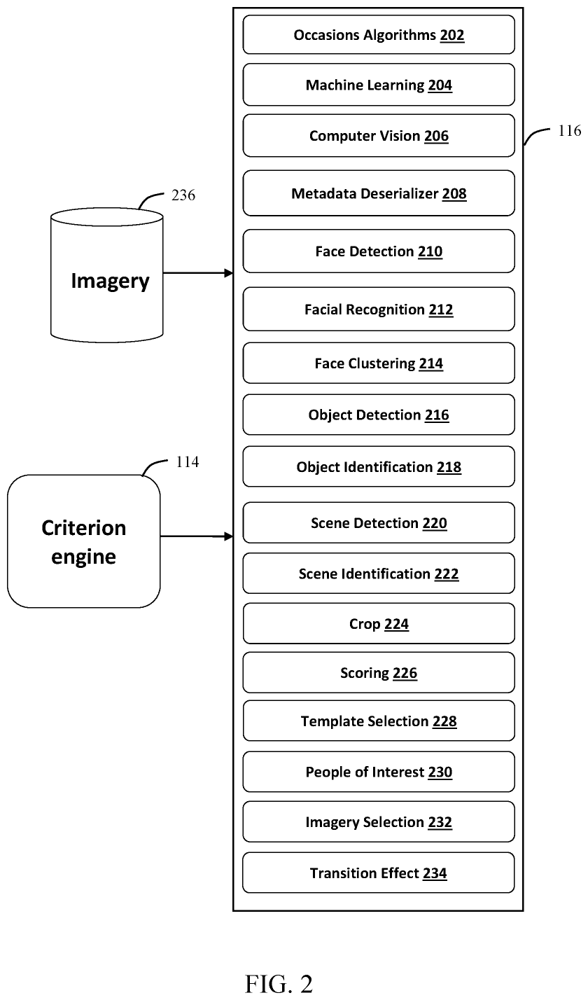

The imagery analysis module 116 analyzes the received imagery in accordance with the one or more criterion. FIG. 2 illustrates the imagery analysis module 116 of FIG. 1 in more detail in accordance with one embodiment. The imagery analysis module 116 may include components that include, but are not limited to, occasions algorithms 202, a machine learning module 204, a computer vision module 206, a metadata deserializer 208, a face detection module 210, a facial recognition module 212, a face clustering module 214, an object detection module 216, an object identification module 218, a scene detection module 220, a scene identification module 222, a cropping module 224, a scoring module 226, a template selection module 228, a people of interest module 230, an imagery selection module 232, and a transition effect module 234.

Any of these components of the imagery analysis module 116 may, alone or in some combination, analyze received imagery 236 to determine if the imagery 236 satisfies one or more specified rules processed by the criterion engine 114.

The occasions algorithms 202 may include algorithms that recognize certain dates, calendar events, or other types of occasions such as those defined by the previously-discussed templates. These may recognize, for example, certain calendar dates that correspond to holidays.

The machine learning module 204 may implement a variety of machine learning procedures to tag the contents of received imagery 236 and to learn about the imagery 236, their content, and the users' behavior related to the imagery 236. Accordingly, the machine learning module 204 may implement supervised machine learning techniques as well as unsupervised machine learning techniques.

The computer vision module 206 may implement a variety of vision techniques to analyze the content of the received imagery 236. These techniques may include, but are not limited to, scale-invariant feature transform (SIFT), speeded up robust feature (SURF) techniques, or the like. The exact techniques used may vary as long as they can analyze the content of the received imagery 236 to accomplish the features of various embodiments described herein.

Computer vision tags may include, but are not limited to, water, nature, no person, person, desktop, outdoors, ocean, summer, sea, sun, panoramic, color, travel, beautiful, bright, fair weather, winter, abstract, vacation, art, or the like. These tags may help classify or otherwise group imagery portions according to their content.

The metadata deserializer 208 may receive various types of metadata (e.g., in a serialized form). This data may include, but is not limited to, EXIF data that specifies the formats for the received imagery 236. The deserializer 208 may then deserialize the received metadata into its deserialized form.

The face detection module 210 may execute a variety of facial detection programs to detect the presence of faces (and therefore people) in various imagery portions. The programs may include or be based on OPENCV and, specifically, neural networks, for example. Again, these programs may execute on the user device 102 and/or on a server at a remote location. The exact techniques or programs may vary as long as they can detect facial features in imagery to accomplish the features of various embodiments described herein.

The face recognition module 212 may execute a variety of facial recognition programs to identify certain people in various imagery portions. The face recognition module 212 may be in communication with one or more databases 130 that store data regarding people and their facial characteristics. The face recognition module 212 may use geometric-based approaches and/or photometric-based approaches, and may use techniques based on principal component analysis, linear discriminant analysis, elastic bunch graph matching, HMM, multilinear subspace learning, or the like.

Face attributes detected by either the face detection module 210 or the face recognition module 212 may include, but are not limited to, Hasglasses, Hassmile, age, gender, and face coordinates for: pupilLeft, pupilRight, noseTip, mouthLeft, mouthRight, eyebrowLeftOuter, eyebrowLeftInner, eyeLeftOuter, eyeLeftTop, eyeLeftBottom, eyeLeftInner, eyebrowRightInner, eyebrowRightOuter, EyeRightlnner, eyeRightTop eyeRightBottom, eyeRightOuter, noseRootLeft, noseRootRight, noseLeftAlarTop, noseRightAlarTop, noseLeftAlarOutTip, noseRightAlarOutTip, upperLipTop, upperLipBottom, underLipTop, underLipBottom.

The imagery analysis module 116 may also implement a positive/negative face aesthetics neural network to select the best imagery portions. For example, the neural network may select imagery portions of a person with their eyes open over imagery portions of the person with their eyes closed. There may be a plurality of imagery aesthetics that may be considered. The imagery analysis may detect which photos are blurry and which are focused, which are centered appropriately, etc. These features may contribute to one or more scores assigned to an imagery portion (discussed below).

The face clustering module 214 may, once the face recognition module 212 identifies a certain person in an imagery portion, group the imagery portion as being part of imagery associated with one or more people. That is, an imagery portion may be one of many identified as including a certain person.

These modules 210-214 may singularly or in some combination extract meaning from the imagery based on who is in the imagery, how often, and with who in order to identify, for example, people that are likely the most relevant. This may allow the imagery analysis module 116 to, for example, detect a family and members thereof, and ensure there is at least one imagery portion of each family member in the generated presentation file.

The imagery analysis module 116 may determine and identify family members in imagery. Additionally or alternatively, a user may manually identify family members in previously-gathered imagery as part of a training phase to indicate “people of interest” or can identify family members or other important people during creation of the presentation file.

The object detection module 216 may detect various objects present in an imagery portion. For example, the object detection module 216 may execute one or more of various techniques (e.g., using the computer vision module 206) to distinguish between an object in an imagery portion and the background of an imagery portion.

The object identification module 218 may then classify or otherwise recognize the object as a certain item. For example, the object identification module 218 may analyze objects (e.g., by their shape, size, color, etc.) to determine if they satisfy one or more criterion. The object identification module 218 may also compare data regarding the detected objects (e.g., their shape and size) to data in the database 148 to determine if the detected object matches an object stored in the database 148 and therefore satisfies one or more criteria.

The scene detection module 220 may gather data that corresponds to the scene of an imagery portion. This may include data that indicates the context of an imagery portion such as whether the imagery portion includes people, was taken indoors, outdoors, during the day, during the night, etc.

The scene identification module 222 may be in communication with the scene detection module 220 and receive data regarding the scene of an imagery portion. The scene identification module 222 may compare the received data to data in the database 148 to determine whether it is indicative of a certain context and therefore satisfies one or more criterion. For example, the scene identification module 222 may identity whether a photograph of a person was taken indoors, outdoors, in certain types of weather, in certain lighting conditions, or the like.

The cropping module 224 may perform any editing steps to the imagery such as cropping individual imagery portions. For example, if one or more people are detected in an imagery portion, the cropping module 224 may crop the imagery portion so that the people's faces are selected and shown more prominently in the generated presentation file.

The scoring module 226 may assign each imagery portion a score that represents whether (and to what degree) an imagery portion satisfies the provided criteria. Accordingly, portions of imagery that have, say, higher scores or scores above a threshold may be selected as opposed to imagery portions having lower scores or scores below a threshold.

The scoring module 226 may assign a score to an imagery portion in a variety of ways. For example, a given presentation file project may specify that imagery portions included in the generated presentation file should (i) include a certain individual; (ii) be taken at a certain location; and (iii) include certain objects of interest (e.g., party hats, a birthday cake, and presents). Items (i) and (ii) may be strictly required, such that imagery portions that do not include both items (i) and (ii) are assigned a score of zero (0) and are not selected.

However, imagery portions that meet criteria (i) and (ii), as well as at least one of (iii) the specified objects of interest, may be assigned a non-zero score that increases with the more objects of interest that are present. That is, an imagery portion that meets criteria (i) and (ii) above, and includes party hats and a birthday cake, is assigned a higher score than an imagery portion that meets criteria (i) and (ii) and just a birthday cake.

Also, and as discussed previously, the imagery analysis module 116 may implement a positive/negative aesthetics neural network to select the best imagery potions. For example, imagery portions with people smiling may be assigned higher scores than imagery portions with people frowning or with food in their mouth. As discussed above, imagery portions that are clear or focused may be assigned higher scores than imagery portions that are blurry. Accordingly, the score(s) assigned to each imagery portion may be based on any number of criteria.

If a certain person or several people have been identified as important, imagery portions with these people may be assigned higher scores and imagery portions without these people. Similarly, an imagery portion that includes three people that have been identified as important may be assigned a higher score than an imagery portion that includes only one person identified as important.

The classification of whether a person is “important” may be based on how frequently the person appears in received imagery. This classification may also be based on how prominently people are shown in imagery. As another example, a person that frequently appears in imagery with another person already classified as important may also be classified as important.

Accordingly, the scoring module 226 may calculate one or more types of scores to be used in selecting imagery. These may include a novelty score that represents how novel or unique an imagery portion is, an important person score representing whether (and how many) important people are in the imagery portion, or any other type of score related to some characteristic of the imagery portion. The scoring module 224 may also calculate a composite score that is based on one or more other types of calculated scores.

The template selection module 228 may, based on the analysis of the received imagery, select a template to be used to analyze the received imagery. For example, if the computer vision module 206 detects a cake in a portion of imagery, the template selection module 228 may select a “birthday” template to be used to analyze other portions of received imagery. The selected template may then specify other criteria for subsequently-received imagery.

The people of interest module 230 may, based on the analysis of received imagery, identify people of interest as criterion. For example, if the computer vision module 206 of the racial recognition module 212 recognize a certain first person in an imagery portion, the people of interest module 230 may specify other people that should be included in the generated presentation file (e.g., the person's friends, spouse, parents, or the like).The imagery selection module 232 may then select one or more imagery portions. In some embodiments, the imagery selection module 232 may select one or more imagery portions based on their assigned scores. As discussed previously, the imagery selection module 232 may be configured to select only imagery portions with a score equal to or above some threshold. In some embodiments, the imagery selection module 232 may select the imagery portions with, e.g., the top ten highest assigned scores to be included in the generated presentation file. In some embodiments, the imagery selection module 232 may sort the gathered imagery portions into different temporal segments, and then select one or more imagery portions with the highest assigned score(s) in each temporal segment.

The imagery selection module 232 may select an amount of imagery portions from a given temporal segment that is proportional to the amount of imagery portions in each segment. That is, a first temporal segment with fifteen (15) imagery portions will have a greater number of imagery portions selected therefrom than a second temporal segment with nine (9) imagery portions, assuming all imagery portions satisfy the specified criteria.

The transition effect module 234 may provide some type of transition effect between the presentation of at least two imagery portions of the generated presentation file. These may include, for example, sound effects or visual effects to enhance the presentation file.

Referring back to FIG. 1, the presentation file generation module 118 may compile the selected imagery portions together to form a presentation file, such as a video slideshow. Essentially, the presentation file generation module 118 mergers the selected imagery portions with one or more templates to generate the presentation file. The presentation file generation module 118 may format the presentation file in accordance with various characteristics. For example, the user 106 may specify the desired duration of the generated presentation file, the number of imagery portions to be included in the presentation file, the amount of time for which each imagery portion should be displayed in the presentation file during presentation, etc.

The presentation file generation module 118 may also execute a text generation module 142 to generate a caption to accompany one or more imagery portions. The text generation module 142 may rely on data regarding the imagery portions obtained from the various sub-modules of the imagery analysis module 116 in generating the caption(s).

Captions may take into account the person or people in the imagery portion, as well as their activities depicted in the imagery portion. This provides an additional layer of context and enjoyment for those viewing the generated presentation file. The captions may take into account what is present in the imagery portions as well as a photographed or recorded person's name (e.g., “Jack flying high on an airplane”), the person's location (“the family spent most of their day at Disneyworld”), landmarks (“mom and dad at the Eiffel Tower”), and time of day (“Myra had a great start to her day with a big breakfast”).

The presentation file generation module 118 may also include or otherwise execute a filter selection module 144 to enhance the generated presentation file. For example, one or more filters can provide visual effects to one or more imagery portions. These filters may provide lighting effects, shadow effects, color effects, or the like, to further enhance or customize the generated presentation file.

The transition selection module 146 may select and apply one or more transition effects to the generated presentation file. These transitions may provide visual or audio effects during the execution of the presentation file, such as when the presentation file switches between presenting different imagery portions. Accordingly, the presentation file generation module 118 may utilize filters, backgrounds, transitions, music, animations, augmented reality features, or the like, to generate the presentation file.

However, the presentation file generation module 118 may be limited by rules or parameters that set, caps, maximums, or limits on the number of filters, captions, or text used in generating the presentation file. This may ensure variety in that, for example, the same filter or transition effects are not excessively used and to achieve diversity in the generated presentation file.

The presentation file generation module 118 may also generate the presentation file to comply with any time parameters or constraints. For example, a user may specify that the generated presentation file should be, for example, 15 seconds in length, 30 seconds in length, 60 seconds in length, etc. Accordingly, the presentation file generation module 118 may format that presentation file such that each imagery portion is presented for a certain number of seconds such that the entire presentation file complies with the specified time constraints. The presentation file generation module 118 may also generate a plurality of presentation files for viewing, wherein each generated presentation file is of a different length.

Additionally or alternatively, the presentation file generation module 118 may determine or at least recommend an appropriate duration for a generated file presentation. For example, based on the amount of imagery received, recommend that a presentation file should be two minutes in length. This recommendation may be presented to a user, who may accept the recommendation or select another duration for the generated file presentation.

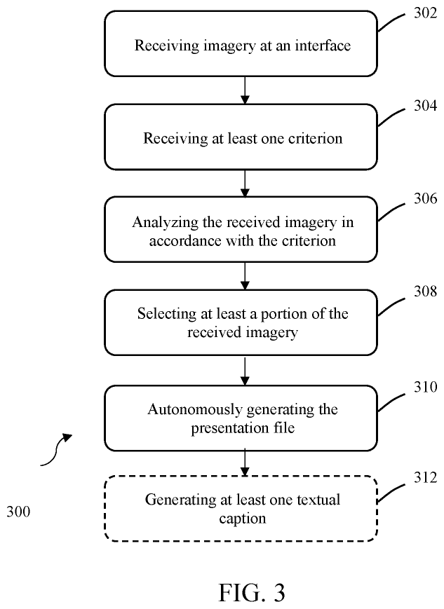

FIG. 3 depicts a flowchart of a method 300 of generating a presentation file in accordance with one embodiment. The system 100 of FIG. 1, or components thereof, may perform the steps of method 300.

Step 302 involves receiving imagery at an interface. The imagery may include several different types of imagery such as those discussed previously. The imagery may be received from or otherwise provided by a plurality of users or project members. The imagery may be received from a shared pool of imagery contributed by several users, and may contain videos and photos taken using smartphones or, e.g., DSLR cameras or any other device. This pool can also include photos contributed by professional photographers hired by an event organizer, for example. Lastly, imagery ingested from social media can also be incorporated into the presentation file to accomplish the various features of the embodiments described herein.

Step 304 involves receiving at the interface at least one criterion for selecting imagery from the received imagery. One or more users may provide criteria for selecting imagery to be included in a generated presentation file. The provided criteria may specify that in order for an imagery portion to be selected for inclusion in a presentation file, it should, for example, be taken at a certain time, be taken at a certain location, include a certain person, include a certain object, or the like.

Step 306 involves analyzing the received imagery in accordance with the received at least one criterion. An imagery analysis module such as the imagery analysis module 116 of FIG. 1 may analyze the received imagery to determine which, if any, imagery portions satisfy the required criterion.

Step 308 involves selecting at least a portion of the received imagery based on the portion satisfying the at least one criterion. Upon determining that one or more imagery portions satisfy the received criterion, an imagery selection module such as the imagery selection module 232 of FIG. 2 may select those imagery portions to be included in a presentation file.

Step 310 involves autonomously generating the presentation file that includes the selected portion of the received imagery. A presentation file generation module such as the presentation file generation module 118 of FIG. 1 may generate the presentation file. The presentation file may be enhanced with, for example, filters, backgrounds, transitions, music, animations, augmented reality features, or the like.

For example, step 312 is optional and involves generating at least one textual caption to accompany the selected portion of the received imagery in the generated presentation file. A text generation module such as the text generation module 132 of FIG. 1 may perform this step. Accordingly, the generated presentation file may be accompanied by captions that describe or otherwise further enhance the content of the generated presentation file.

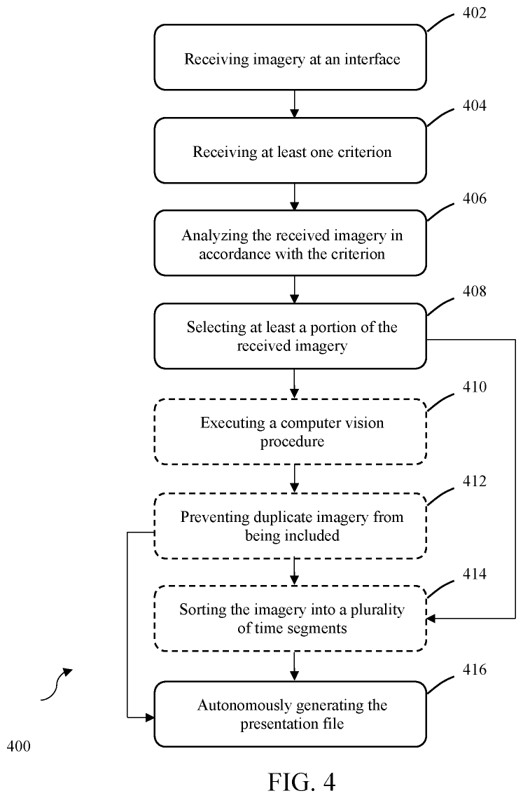

FIG. 4 depicts a flowchart of a method 400 of generating a presentation file in accordance with another embodiment. The system 100 of FIG. 1, or components thereof, may perform the steps of method 400. Steps 402-408 are similar to steps 302-308, respectively, of

FIG. 3 and are not repeated here.

Step 410 involves executing a computer vision procedure to review the received imagery for duplicate imagery. For example, a computer vision module such as the computer vision sub-module 206 may execute any one or more of appropriate computer vision procedures to analyze received imagery to detect the content thereof. Specifically, the computer vision sub-module 206 may detect instances in which two or more imagery portions are at least substantially similar that they are considered duplicates.

In some embodiments, the computer vision sub-module 206 may not only detect instances in which imagery portions are substantially similar, but also to ensure there is some variety amongst selected imagery portions. For example, based on the analysis conducted by the computer vision sub-module 206, the scoring module 226 may assign imagery portions scores that represent their similarity. If two or more imagery portions have similarity scores, e.g., above a threshold (and therefore indicating they are quite similar), only one of the imagery portions may be chosen. Accordingly, the imagery analysis module 116 may select imagery portions that are dissimilar to ensure there is variety in the imagery portions included in the generated file presentation.

Similarity scores may be based on, for example, the background of the imagery portion, the location of the imagery portion, people present in the imagery portion, or the like. For example, if a first imagery portion includes three people in front of the Eiffel Tower and a second imagery portion includes the same three people in front of the Eiffel Tower but in different poses, only one of these imagery portions may be selected to ensure variety in the generated file presentation.

Accordingly, step 412 involves preventing duplicate imagery from being included in the generated presentation file. This step may be performed by an imagery selection module such as the imagery selection module 232 of FIG. 2.

Step 414 involves sorting the imagery into a plurality of time segments based on when the imagery was taken. For example, the imagery selection module 232 of FIG. 2 may group imagery portions into a plurality of temporal segments, such as those one hour in duration. The imagery selection module 232 may select imagery from each of the plurality of time segments, with the amount of imagery selected from each of the plurality of time segments being proportional to the amount of imagery in each of the plurality of time segments.

Step 416 is similar to step 310 of FIG. 3, and involves autonomously generating the presentation file. The presentation file generation module 118 may consider time or date data associated with the selected imagery portions when generating the presentation file. For example, the presentation file generation module 118 may organize the presentation file such that imagery portions taken on a Monday are organized to come before imagery portions taken on the following Wednesday. Similarly, imagery portions taken in the morning may be presented before imagery portions taken in the evening on the same day.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur out of the order as shown in any flowchart. For example, two blocks shown in succession may in fact be executed substantially concurrent or the blocks may sometimes be executed in the reverse order, depending upon the functionality/acts involved. Additionally, or alternatively, not all of the blocks shown in any flowchart need to be performed and/or executed. For example, if a given flowchart has five blocks containing functions/acts, it may be the case that only three of the five blocks are performed and/or executed. In this example, any of the three of the five blocks may be performed and/or executed.

A statement that a value exceeds (or is more than) a first threshold value is equivalent to a statement that the value meets or exceeds a second threshold value that is slightly greater than the first threshold value, e.g., the second threshold value being one value higher than the first threshold value in the resolution of a relevant system. A statement that a value is less than (or is within) a first threshold value is equivalent to a statement that the value is less than or equal to a second threshold value that is slightly lower than the first threshold value, e.g., the second threshold value being one value lower than the first threshold value in the resolution of the relevant system.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of various implementations or techniques of the present disclosure. Also, a number of steps may be undertaken before, during, or after the above elements are considered.

Having been provided with the description and illustration of the present application, one skilled in the art may envision variations, modifications, and alternate embodiments falling within the general inventive concept discussed in this application that do not depart from the scope of the following claims.

What is claimed is:

1. A method of generating a presentation file, the method comprising:
receiving imagery at an interface;
receiving at the interface at least one criterion for selecting imagery from the received imagery;
analyzing the received imagery in accordance with the received at least one criterion;
selecting at least a portion of the received imagery based on the portion satisfying the at least one criterion; and
autonomously generating the presentation file that includes the selected portion of the received imagery.

2. The method of claim 1 further comprising assigning a score to the received imagery that represents whether the received imagery satisfies the received at least one criterion.

3. The method of claim 2 wherein the score assigned to the received imagery is based on at least one item of interest in the received imagery, wherein the item of interest is selected from the group consisting of a person in the imagery, a location where the imagery was taken, a date the imagery was taken, a time the imagery was taken, a point of interest associated with the imagery, an object of interest in the imagery, and at least one imagery aesthetic.

4. The method of claim 3 wherein a higher score is assigned to a first portion of imagery that includes more items of interest than a score assigned to a second portion of imagery with fewer items of interest.

5. The method of claim 1 further comprising generating at least one textual caption to accompany the selected portion of the received imagery in the generated presentation file.

6. The method of claim 5 wherein the at least one textual caption describes at least one of a person in the selected portion of the received imagery, an activity occurring in the selected portion of the received imagery, a point of interest in the imagery, and an object of interest in the imagery.

7. The method of claim 1 wherein receiving the imagery at an interface includes receiving the imagery from a plurality of users.

8. The method of claim 1 further comprising:
executing a computer vision procedure to review the received imagery for duplicate imagery, and
preventing duplicate imagery from being included in the generated presentation file.

9. The method of claim 1 wherein analyzing the received imagery includes a computer vision procedure to review the imagery to detect similar imagery, wherein selecting at least a portion of the received imagery includes selecting imagery portions that are most dissimilar to ensure the generated file presentation includes diverse imagery.

10. The method of claim 1 further comprising, based on the analysis of the received imagery, recommending a template to be used to generate the presentation file.

11. The method of claim 1 wherein generating the presentation file includes selecting at least one filter to be used, and applying the at least one filter to at least a portion of the selected imagery.

12. The method of claim 1 further comprising sorting the imagery into a plurality of time segments based on when the imagery was taken, and wherein selecting at least a portion of the received imagery comprises selecting imagery from each of the plurality of time segments, with the amount of imagery selected from each of the plurality of time segments being proportional to the amount of imagery in each of the plurality of time segments.

13. The method of claim 1, wherein generating the presentation file that includes the selected portion of the received imagery includes applying at least one filter to the selected portion of the received imagery, wherein the applied filter is based on content of the received imagery.

14. The method of claim 1 wherein analyzing the received imagery includes executing a computer vision procedure, and the method further includes executing a cropping procedure to crop the portion of the selected imagery based on the execution of the computer vision procedure.

15. A system for generating a presentation file, the system comprising:
an interface for receiving:
imagery, and
at least one criterion for selecting imagery from the received imagery; and
a processor executing instructions stored on memory and configured to:
analyze the received imagery in accordance with the received at least one criterion;
select at least a portion of the received imagery based on the portion satisfying the at least one criterion; and
autonomously generate the presentation file that includes the at least one selected portion of the received imagery.

16. The system of claim 15 wherein the processor is further configured to assign a score to the received imagery that represents whether the received imagery satisfies the at least one criterion.

17. The system of claim 15 wherein the score assigned to the received imagery is based on at least one item of interest in the received imagery, wherein the item of interest is selected from the group consisting of a person in the imagery, a location where the imagery was taken, a date the imagery was taken, a time the imagery was taken, a point of interest associated with the imagery, an object of interest in the imagery, and at least one imagery aesthetic.

18. The system of claim 17 wherein a higher score is assigned to a first portion of imagery that includes more items of interest than a score assigned to a second portion of imagery with fewer items of interest.

19. The system of claim 15 wherein the processor is further configured to generate at least one textual caption to accompany the selected portion of the received imagery in the generated presentation file.

20. The system of claim 19 wherein the at least one textual caption describes at least one of a person in the selected portion of the received imagery, an activity occurring in the selected portion of the received imagery, a point of interest in the activity, and an object of interest in the imagery.

21. The system of claim 15 wherein the imagery is received from a plurality of users.

22. The system of claim 15 wherein the processor is further configured to:
execute a computer vision procedure to review the received imagery for duplicate imagery, and
prevent duplicate imagery from being included in the generated presentation file.

23. The system of claim 15 wherein the processor is further configured to:
execute instructions stored in memory to autonomously analyze metadata associated with the received imagery, and
sort the selected imagery into a plurality of time segments based on when the imagery was taken, wherein the amount of imagery selected from each of the plurality of time segments is proportional to the amount of imagery in each of the plurality of time segments.

24. The system of claim 15 wherein the processor is further configured to assign a transition effect between presentation of at least two imagery portions of the generated presentation file.
